(19) United States
(12) Patent Application Publication
(10) Pub. No.: US 2013/0213516 A1
(43) Pub. Date: Aug. 22, 2013

(54) Universal Pipe Thread Protector

(71) Applicants: David W. Clem, Spring, TX (US); Jeffrey D. Lendermon, Missouri City, TX (US); Bryan C. Baker, Houston, TX (US)

(72) Inventors: David W. Clem, Spring, TX (US); Jeffrey D. Lendermon, Missouri City, TX (US); Bryan C. Baker, Houston, TX (US)

(73) Assignee: DRILLTEC PATENTS AND TECHNOLOGIES CORPORATION, Houston, TX (US)

(21) Appl. No.: 13/588,394

(22) Filed: Aug. 17, 2012

Related U.S. Application Data
(60) Provisional application No. 61/526,611, filed on Aug. 23, 2011.

(51) Int. Cl. F16L 57/00

(52) U.S. Cl. CPC F16L 57/00
USPC 138/96 T

(57) ABSTRACT

A protector for protecting a helical thread of a pipe comprises a body. The body has a central axis, an upper end comprising a base, a lower end opposite the upper end, and an annular connecting member extending axially from the base to the lower end. The connecting member comprising a radially inner surface and a radially outer surface. The connecting member comprises a helical thread extending radially inward from the radially inner surface or radially outward from the radially outer surface. The helical thread comprises a convex profile that is different than a thread profile of the thread of the pipe.

### CROSS-REFERENCE TO RELATED APPLICATIONS

This application claims benefit of U.S. provisional patent application Ser. No. 61/526,611 filed Aug. 23, 2011, and entitled “Universal Pipe Thread Protector,” which is hereby incorporated herein by reference in its entirety.

### STATEMENT REGARDING FEDERALLY SPONSORED RESEARCH OR DEVELOPMENT

Not applicable.

### BACKGROUND

1. Field of the Invention

The invention relates generally to devices for protecting the ends of pipes and tubulars. More particularly, the invention relates to devices for protecting the threads on the ends of pipes.

2. Background of the Technology

Pipes, such as pipes used for oil and gas drilling and production, are often produced in sections and are axially connected end-to-end. Typically, the connection involves the use of a male, externally threaded portion at one end of one pipe section that is threadingly engageable with a mating female, internally threaded portion at the end of an axially adjacent pipe section. The male, externally threaded end of a pipe is often referred to as the pin end, and the female, internally threaded end of a pipe is often referred to as the box end.

The ends of the pipe, including the threads, are subject to damage when not in actual use, such as from corrosion, impacts with other objects, or from being dropped during transportation or storage. Such damage may render the pipe faulty or unusable, resulting in delay, hardship and increased expense. Devices known as thread protectors are commonly used to protect the ends of pipes, and in particular, to protect the internal and external threads on the ends of pipes from such damage. A pin end thread protector is connected to and protects the pin end of the pipe and associated external threads, and a box end thread protector is connected to and protects the box end of the pipe and associated internal threads. The thread protectors are designed to prevent damage to the respective pipe ends when the pipe impacts other objects, the ground or otherwise is subjected to external impacts. In addition, the thread protectors are designed to seal the ends of the pipe to reduce the potential for premature corrosion of the pipe and/or threads.

Pipes used for oil and gas drilling and production can vary in nominal diameter from two inches to over thirty inches. Further, many pipe manufacturing companies and exploration and production (E&P) companies have developed proprietary thread forms dictating thread geometry (e.g., square threads, trapezoidal threads), thread size (e.g., thread height), and thread pitch (e.g., the number of threads per inch). In addition, the American Petroleum institute (API) has several thread form standards. As a result, there are over 3,000 different combinations of pipe diameters and thread forms (i.e., thread geometries and thread pitches).

To protect both the pin end and box end of a pipe section, conventional thread protectors typically come in two types—a pin end thread protector that is disposed about the pin end of the pipe and includes internal threads that engage the external threads on the pin end, and a box end thread protector that is positioned in the box end of the pipe and includes external threads that engage the internal threads on the box end. The pin end thread protector is sized, configured, and designed such that its internal threads mate with the external threads of the pin end; and the box end thread protector is sized, configured, and designed such that its external threads mate with the internal threads of the box end. In other words, the internal threads of the pin end protector fit between the external threads of the pin end as the pin end protector is threaded onto the pin end, and the external threads of the box end protector fit between the internal threads of the box end as the box end protector is threaded onto the box end. For example, FIG. 1A illustrates a conventional pin end thread protector 10 disposed about a pin end 20 of a pipe section 50. Pin end thread protector 10 includes internal threads 11 that mate and engage with external threads 21 on pin end 20 of pipe section 50. Specifically, internal threads 11 are designed to have the same thread pitch, size, and geometry as external threads 21 to allow internal threads 11 to fit between and mate with external threads 21 of pin end 20. As shown in FIG. 1A, internal threads 11 typically engage the runout or L4 length of the external threads 21, or at least the L2 length of the external threads 21. As is known in the art, the runout or L4 length is the full axial length of threads measured to the plane of the vanishing point of the threads, and the L2 length is the axial length of the threads measured to the plane of the last full, perfect thread (i.e., the plane of effective thread length).

In FIG. 1B, a conventional box end thread protector 30 is shown disposed about a box end 40 of pipe section 50. Box end thread protector 30 includes external threads 31 that mate and engage with internal threads 41 on box end 30. Specifically, external threads 31 are designed to have the same thread pitch, size, and geometry as internal threads 41 to allow external threads 31 to fit between and mate with internal threads 41 of box end 40. As shown in FIG. 1B, the external threads (e.g., external threads 31) of a thread protector typically engage the L4 length of the internal threads (e.g., internal threads 41), or at least the L2 length of the internal threads.

As previously described, there are over 3,000 different combinations of pipe diameter and thread form. Accordingly, there are hundreds of different thread protectors, each sized, configured, and designed to mate with the particular combination of pipe diameter and pipe thread form. Significant time and expense are associated with the manufacture of such a large number of different thread protectors, as well as the storage of such a large number of different thread protectors.

Accordingly, there remains a need in the art for a thread protector capable of protecting pipe ends having different thread forms. Such thread protectors would be particularly well received if they offered the potential to reduce manufacturing costs and inventory costs and were configured for multiple re-uses.

### BRIEF SUMMARY OF THE DISCLOSURE

These and other needs in the art are addressed in one embodiment by a protector for protecting a helical thread of a pipe having a central axis, a thread pitch Pₚ, a radial thread height Hₚ, an axial thread width Wₚ, an L4 length, an L2 length, and a thread profile. In an embodiment, the protector comprises a body. The body has a central axis, an upper end comprising a base, a lower end opposite the upper end, and an annular connecting member extending axially from the base to the lower end. The connecting member comprising a radially inner surface and a radially outer surface. The connecting member comprises a helical thread extending radially inward from the radially inner surface or radially outward from the radially outer surface. The helical thread comprises a convex profile that is different than a thread profile of the thread of the pipe.

These and other needs in the art are addressed in another embodiment by a method for protecting a pipe thread. In an embodiment, the method comprises providing a thread protector having a central axis. The thread protector comprises a base and an annular connecting member extending axially from the base. The connecting member comprising a radially inner surface and a radially outer surface. The radially outer surface or the radially inner surface of the connecting member comprises a helical thread. The helical thread comprises a convex profile. In addition, the method comprises coaxially aligning the thread protector with a pipe. The pipe has a radially outer surface, a radially inner surface, and a helical thread extending from a terminal end of the pipe along the radially inner surface or radially outer surface of the pipe. The helical thread of the pipe having a thread profile that is different from the convex profile of the helical thread of the connecting member. Further, the method comprises rotating the thread protector in a threading direction about the central axis and advancing the thread protector and the terminal end of the pipe axially together. Still further, the method comprises threadingly engaging the helical thread of the pipe with the helical thread of the thread protector.

These and other needs in the art are addressed in another embodiment by an assembly. In an embodiment, the assembly comprises a pipe having a central axis, a radially inner surface, a radially outer surface, and a helical thread extending about the radially outer surface or a radially inner surface of the pipe. The helical thread of the pipe has a thread pitch Pₚ, a radial thread height Hₚ, an axial thread width Wₚ, an L4 length, art L2 length that is less than the L4 length, and a thread profile. In addition, the assembly comprises a thread protector threadingly coupled to the pipe. The thread protector comprises a base and an annular connecting member having a first end connected to the base and a second end distal the base. The connecting member has a radially inner surface, a radially outer surface, and a helical thread extending about the radially inner surface or the radially outer surface of the connecting member. The helical thread of the connecting member is positioned between the first end and the second end of the connecting member. The helical thread of the connecting member has an axial length that is less than the L2 length of the helical thread of the pipe.

Embodiments described herein comprise a combination of features and advantages intended to address various shortcomings associated with certain prior devices, systems, and methods. The foregoing has outlined rather broadly the features and technical advantages of the invention in order that the detailed description of the invention that follows may be better understood. The various characteristics described above, as well as other features, will be readily apparent to those skilled in the art upon reading the following detailed description, and by referring to the accompanying drawings. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1A is a cross-sectional view of a conventional pin end thread protector;

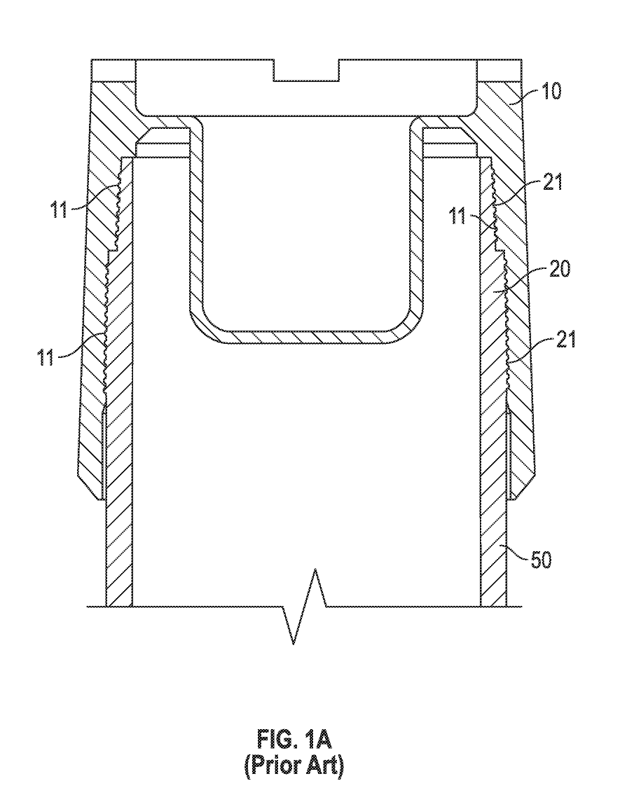

FIG. 1B is a cross-sectional view of a conventional box end thread protector;

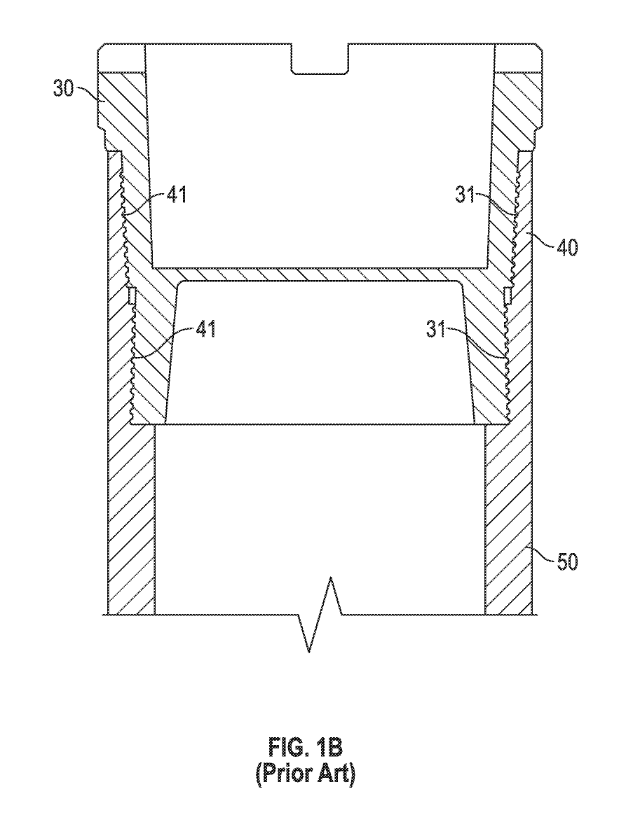

FIG. 2 is a perspective view of an embodiment of a pin end thread protector in accordance with the principles described herein;

FIG. 3 is a top view of the pin end thread protector of FIG. 2;

FIG. 4 is a cross-sectional view of the pin end thread protector of FIG. 2 taken in section 4-4 of FIG. 3;

FIG. 5 is an enlarged partial cross-sectional view of the pin end thread protector of FIG. 2 taken in section 5-5 of FIG. 4;

FIG. 6 is a cross-sectional view of the pin end thread protector of FIG. 2 coupled to the pin end of a pipe section;

FIG. 7 is an enlarged partial cross-sectional view of the pin end thread protector and the pin end of FIG. 2 taken in section 7-7 of FIG. 2;

FIG. 8 is a perspective view of an embodiment of a box end thread protector in accordance with the principles described herein;

FIG. 9 is a top view of the pin end thread protector of FIG. 8;

FIG. 10 is a cross-sectional view of the pin end thread protector of FIG. 8 taken in section 10-10 of FIG. 9;

FIG. 11 is an enlarged cross-sectional view of the pin end thread protector of FIG. 2 taken in section 11-11 of FIG. 10;

FIG. 12 is a cross-sectional view of the box end thread protector of FIG. 8 coupled to the box end of a pipe section; and

FIG. 13 is an enlarged partial cross-sectional view of the box end thread protector and box end of FIG. 2 taken in section 13-13 of FIG. 12.

### DETAILED DESCRIPTION OF SOME OF THE PREFERRED EMBODIMENTS

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis.

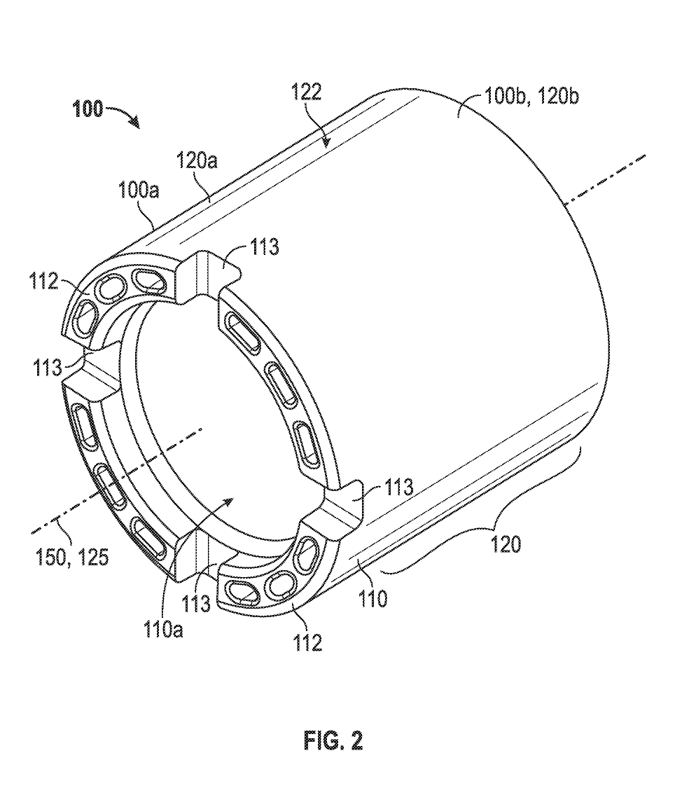

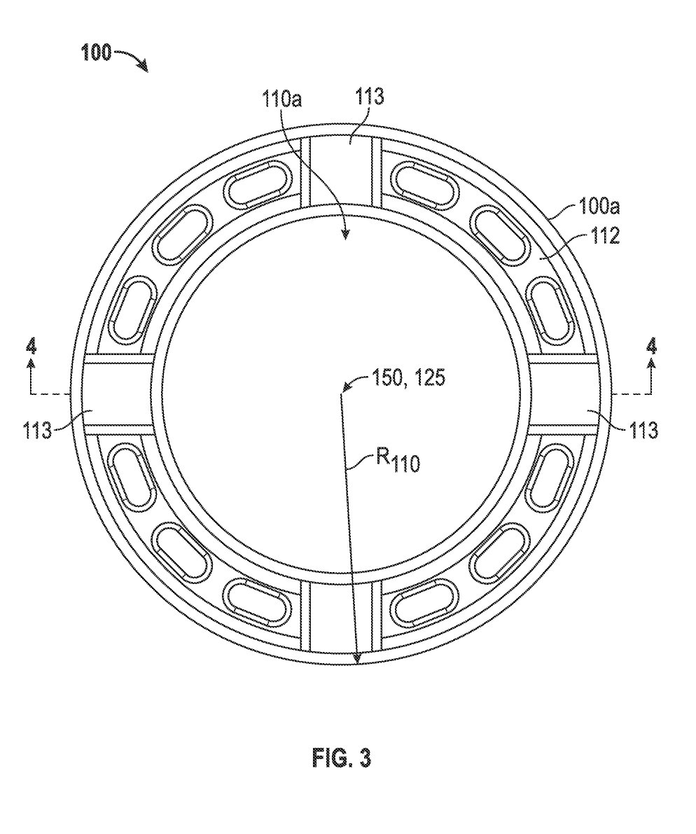

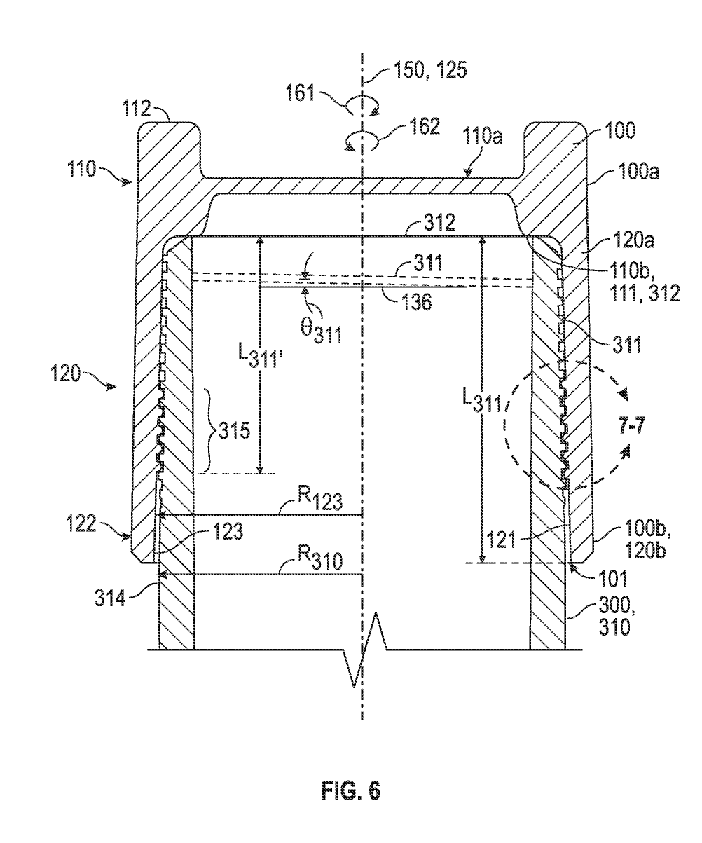

Referring now to FIGS. 2-4 and 6, an embodiment of a pin end thread protector 100 in accordance with the principles described herein is shown. In FIG. 6, thread protector 100 is shown coupled to the pin end 310 of a conventional joint or pipe 300. Once mounted on pin end 310, thread protector 100 protects external thread 311 on pin end 310 from damage (e.g., impacts with other objects, corrosion, etc.).

Thread protector 100 has a central axis 150, an upper, closed end 100a, and a lower, open end 100b opposite end 100a. In addition, thread protector 100 includes a base 110 at closed end 100a and an annular body or connecting member 120 extending axially from base 110 to open end 100b. As best shown in FIG. 6, during use, connecting member 120 coaxially receives pin end 310 of pipe 300 through open end 100b until the terminal end 312 of pin end 310 axially abuts and sealingly engages base 110. Consequently, connecting member 120 may also be described as a female box 120.

Thread protector 100 has a height H₁₀₀ measured axially between ends 100a, b. Height H₁₀₀ is preferably equal to or greater than the axial length L₃₁₁ of the external threads 311 of pin end 310, such that connecting member 120 extends over, completely covers and shields external thread 311 of pin end 310 from damage.

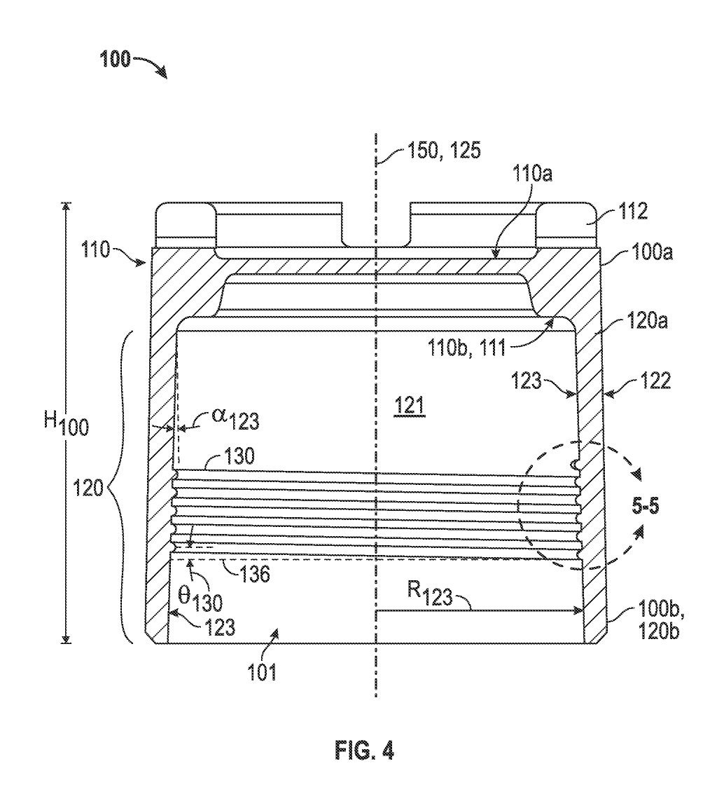

Referring still to FIGS. 2-4 and 6, in this embodiment, base 110 is generally circular with an outer radius R₁₁₀. In addition, base 110 has a planar outer surface 110a and an annular planar inner surface 110b opposite surface 110a. Planar surfaces 110a, 110b lies in planes oriented perpendicular to axis 150. As best shown in FIGS. 4 and 6, the radially outer portion of inner surface 110b defines an annular seat 111 for engaging and scaling against the terminal end 312 of box end 310. An annular bumper 112 extends axially from outer surface 110a of base 110 proximal the radially outer periphery of base 110. Bumper 112 includes a plurality of circumferentially-spaced recesses 113. In this embodiment, four uniformly circumferentially spaced recesses 113 are provided. Recesses 113 provide a structure and mechanism for positively engaging thread protector 100 and applying rotational torque to thread protector 100 to rotate thread protector 100 about axis 150 during installation and removal from pin end 310. Although four recesses 113 uniformly angularly spaced 90° apart about axis 150 are provided in the embodiment shown in FIGS. 2-4 and 6, in general, any suitable number of recesses (e.g., recesses 113) may be provided, and further, the recesses may be uniformly or non-uniformly angularly spaced.

Referring still to FIGS. 2-4 and 6, connecting member 120 has a central axis 125 coaxially aligned with axis 150, an upper, base end 120a connected to base 110, and a lower, free end 120b distal to base 110. A central passage or bore 121 extends axially through connecting member 120 between ends 120a, b and is adapted to at least partially receive pin end 310 (FIG. 6). Base 110 extends across, closes off, and occludes bore 121 at base end 120a. However, at free end 120b, bore 121 is open, thereby defining opening 101 of protector 100.

Connecting member 120 has a radially outer surface 122 and a radially inner surface 123 defining an inner radius R₁₂₃. As best shown in FIG. 4, in this embodiment, surface 123 tapers radially inward moving from five end 120b to base end 120a. In particular, inner surface 123 is oriented at an acute angle α₁₂₃ relative to axes 125, 150. Thus, surface 123 may each be described as frustoconical. As a result, radius R₁₂₃ increases moving axially from base end 120a to free end 120b. In other embodiments, the radially inner surface (e.g., surface 123) of the pin end protector (e.g., protector 100) may be cylindrical (i.e., not tapered).

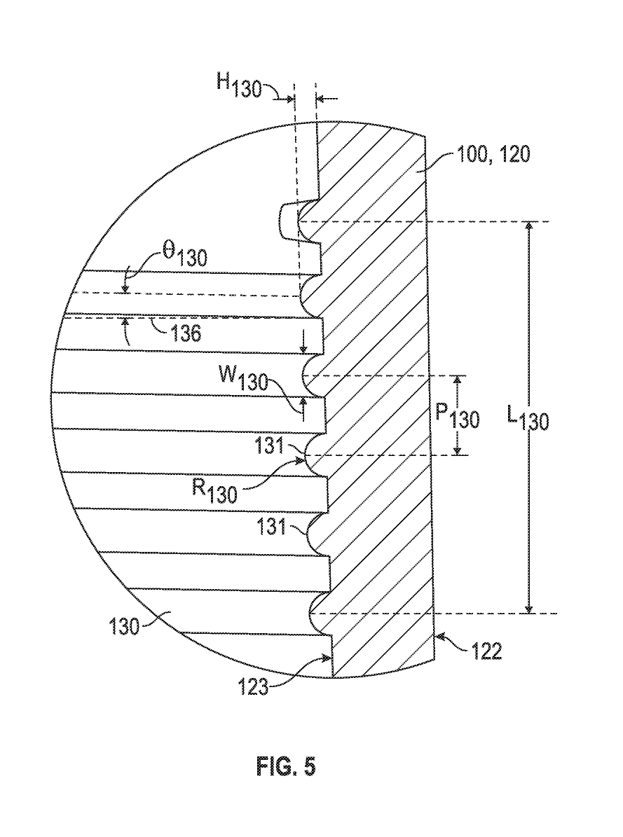

Referring now to FIGS. 4-6, a helical internal thread 130 extends along inner surface 123 of connecting member 120 and is positioned between base end 120a and free end 120b. Thread 130 extends about a helical axis that is coincident with axes 125, 150, and has a thread pitch P₁₃₀ equal to the axial length (center--to-center) of one complete turn of thread 130. In this embodiment, thread 130 is positioned proximal free end 120b and axially spaced from base end 120a. Further, as best shown in FIG. 5, thread 130 extends a length L₁₃₀ measured axially (center-to-center) between the upper and lower ends of thread 130. In this embodiment, axial length L₁₃₀ is less than the runout or L4 length L₃₁₁ of external thread 311 on pin end 310, and more specifically, less than the L2 length L_{311′} of external thread 311. External thread 311 and its L4 length L₃₁₁ and L2 length L_{311′} are discussed in more detail below.

As best shown in FIGS. 4 and 5, thread 130 is oriented at a thread angle θ₁₃₀ relative to a reference plane 136 perpendicular to axis 150. Without being limited by this or any particular theory, thread angle θ₁₃₀ is a function of inner radius R₁₂₃ and thread pitch P₁₃₀. In general, for pin end thread protectors (e.g., thread protector 100), the thread angle (e.g., thread angle θ₁₃₀) is inversely related to the thread protector inner radius (e.g., inner radius R₁₂₃), and directly related to the thread pitch (e.g., thread pitch P₁₃₀). In other words, for a particular thread pitch, as thread protector inner radius increases, thread angle decreases; and for a particular thread protector inner radius, as thread pitch increase, thread angle increase.

Referring now to FIG. 5, the cross-sectional shape of a thread (e.g., thread 130) taken perpendicular to the central axis of the thread may be referred to its geometry or thread profile. In this embodiment, thread 130 has a round, semi-circular or semi-cylindrical profile defined by a convex surface 131 extending radially inward from surface 123. Surface 131 of thread 130 has a radius of curvature R₁₃₀ that is preferably greater than 0.03 in., and more preferably between 0.045 and 0.06 in. In addition, thread 130 has an axial width W₁₃₀ measured at the base of thread 130 equal to twice the radius R₁₃₀ and one-half thread pitch P₁₃₀, and a thread height H₁₃₀ measured radially inward from inner surface 123 to the radially innermost point of thread 130. For most applications, thread height H₁₃₀ is preferably between 0.015 in. and 0.07 in., more preferably between 0.045 in, and 0.065 in., and even more preferably between 0.050 in. and 0.060 in.

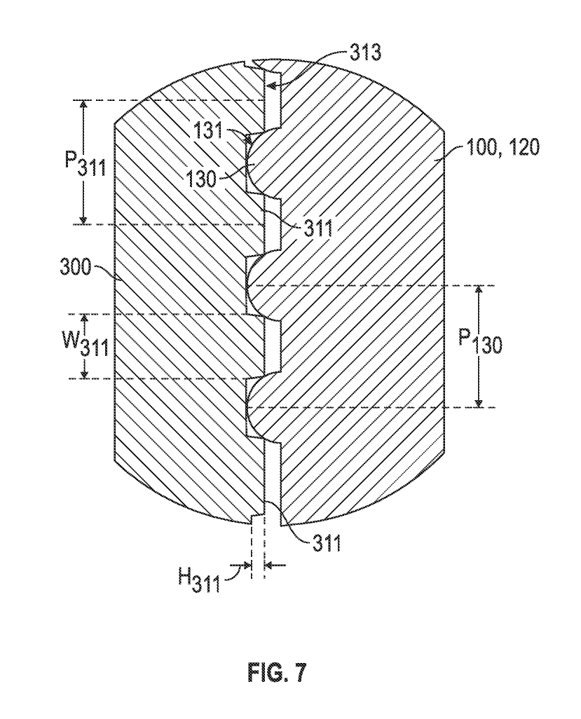

Referring now to FIGS. 6 and 7, pin end thread protector 100 is shown mounted to pin end 310 of conventional pipe 300. Pin end 310 has a frustoconical radially outer surface 314 defining a pin end outer radius R₃₁₀. As is conventional for drilling and production pipes, outer surface 314 tapers inward moving axially towards terminal end 312. Thus, outer radius R₃₁₀ decreases moving axially towards terminal end 312. For most pipes, the outer surface of the pin end (e.g., outer surface 314 of pin end 310) is usually tapered at an angle between 0° and 3° relative to the central axis of the pipe, most often between 1° and 2°. Angle α₁₂₃ of inner surface 123 previously described (FIG. 4) is preferably selected such that inner surface 123 is parallel to the tapered outer surface 314 when protector 100 is mounted to pin end 310. In other words, angle α₁₂₃ of surface 123 is preferably the same as the angle of the radially outer surface of the pin end to which it is mounted. In applications where the outer surface of the pin end is not tapered (e.g., surface 314 of pin end 310 is not tapered), the inner surface of the box (e.g., inner surface 123 of connecting member 120) may be cylindrical (Le., have a constant radius).

External helical thread 311 of pin end 310 extends about pin end 310 and has a runout or L4 length L₃₁₁ measured axially from terminal end 312 to the vanishing point of thread 311. In addition, external thread 311 has L2 length L_{311′} measured axially from terminal end 312 to the last full, perfect thread 311. As best shown in FIG. 7, external thread 311 has a thread pitch P₃₁₁ equal to the axial (center-to center) width of one complete turn of thread 311, a thread height H₃₁₁ measured radially outward from surface 314 to the radially outermost point of thread 311, a thread width W₃₁₁ equal to one-half thread pitch P₃₁₁, a thread angle θ₃₁₁ relative to reference plane 136, and a trapezoidal thread geometry or profile. The pin end of conventional pipes (e.g., pipe 300) typically has 5 to 10 external threads per inch, and thus, usually has a thread pitch between 0.1 in. and 0.2 in.

As previously described, internal thread 130 has a round, semi-circular or semi-cylindrical profile, whereas external thread 311 has a trapezoidal profile. Although threads 130, 311 have different thread profiles (i.e., round vs. trapezoidal), internal thread 130 is configured to threadingly mate with external thread 311 (i.e., each turn of thread 130 is axially disposed between a pair of axially adjacent turns of thread 311). in particular, thread pitch P₁₃₀ of internal thread 130 is the same as the thread pitch P₃₁₁ of external thread 311, and thread angle θ₁₃₀ of internal thread 130 is the same as the thread angle θ₃₁₁ of external thread 311. In addition, protector 100 is sized such that internal thread 130 radially overlaps with external thread 311 when thread protector 100 is threaded onto to pin end 310. Accordingly, inner radius R₁₂₃ minus internal thread height H₁₃₀ is less than outer radius R₃₁₀ plus external thread height H₃₁₁ in an region of threaded engagement 315 between threads 130, 311. Since surfaces 123, 314 are tapered, it should be appreciated that internal threads 130 may not radially overlap with external thread 311 along the entire length L₃₁₁. For example, threads 130, 311 may not radially overlap proximal terminal end 312. However, external thread 311 preferably does not engage inner thread protector surface 123, and internal thread 130 preferably does not engage outer pin end surface 314 when thread protector 100 is mounted to pin end 310. Thread height H₁₃₀ of internal thread 130 can be different than thread height H₃₁₀ of external thread 311, and thread width W₁₃₀ can be different than thread width W₃₁₀ of external thread 311, while still allowing thread 130 to mate and engage with external thread 311.

A conventional pin end thread protector is sized and configured to fit a pin end having a specific combination of diameter, thread pitch, thread angle, thread profile, thread width, and thread height. Embodiments of pin end thread protector 100 described herein are sized and configured to fit a pin end having a specific combination of diameter, thread pitch, and thread angle, but unlike conventional pin end thread protectors, may be used with different combinations of thread profile, thread width, and thread height. In particular, embodiments of pin end protector 100 described herein include an internal thread 130 with a round, semi-circular or semi-cylindrical thread profile for sufficiently engaging any pin end external thread 311 having a thread width W₃₁₀ between 90 and 110% of thread width W₁₃₀ (i.e., thread width W₁₃₀ ranges from 90 to 110% of thread width W₃₁₀), and a thread height H₁₃₀ between 100 and 125% of thread height H₁₃₀ (i.e., thread height H₁₃₀ ranges from 80 to 100% of thread height H₃₁₀). This combination of features enables pin end thread protector 100 to be mounted onto a variety of different pin ends having a given diameter, thread pitch, and thread angle, but different thread profiles, thread heights, and thread widths, while simultaneously ensuring the threaded engagement therebetween is sufficient to pass the standards and tests relating to pin end thread protectors such as the API Specification 5CT/ISO 11960 Requirements for Thread Protector Design Validation including stability tests, torque and vibration tests, axial impact tests, angular impact tests, corrosion test, stripping test, etc. Accordingly, embodiments of pin end thread protector 100 offer the potential for a more versatile thread protector capable of being used with similarly sized pipes having different thread profiles, thread heights, and thread widths. As a result, embodiments of pin end thread protector 100 also offer the potential to reduce thread protector inventory and storage requirements by reducing the number of different thread protectors that must be manufactured and stored to account for all the possible combinations of thread profile, thread width, and thread height for given diameter pin ends having a certain thread pitch and thread angle.

Referring now to FIG. 6, to mount thread protector 100 to pin end 310, terminal end 312 is axially inserted into opening 101 and axially advanced until external thread 311 abuts internal thread 130. Next, rotational torque is applied to thread protector 100 via recesses 113 to rotate thread protector 100 about axis 150 relative to pipe 300 in the direction of arrow 161. Simultaneous with the rotation of thread protector 100, pin end 310 is axially urged through opening 101 and into bore 121, thereby engaging threads 130, 311 and threading pin end thread protector 100 onto pin end 310. Protector 100 is preferably threaded onto pin end 310 until terminal end 312 axially abuts and sealingly engages base 110 along seat 111.

To unthread and remove pin end thread protector 100 from pin end 310, rotational torque is applied to thread protector 100 via recesses 113 to rotate thread protector 100 about axis 150 relative to pipe 300 in the direction of arrow 162 (opposite the direction 161). Simultaneous with the rotation in direction 162, thread protector 100 is axially pulled from pin end 310 until threads 130, 311 are completely disengaged.

As previously described, the internal threads of a conventional pin end thread protector typically engage the L4 length of the external threads of the corresponding pin end, or at least the L2 length of the external threads. However, in embodiments described herein, internal thread 130 of thread protector 100 extends an axial length L₁₃₀ that is less than the L4 length L₃₁₁ of external thread 311 on pin end 310, and further, less than the L2 length L_{311′} of external thread 311. Thus, internal thread 130 does not engage the L4 length L₃₁₁ or L2 length L_{311′} of external thread 311. This enables thread protector 100 to be installed/threaded onto and unthreaded/removed from pin end 310 with less time and effort as compared to a similarly sized conventional thread protector. In particular, with a shorter axial length internal thread 130, protector 100 may be threaded onto and unthreaded from pin end 310 with fewer rotations. However, axial length L₁₃₀ is preferably long enough to enable sufficient engagement of threads 130, 311 to restrict and/or prevent corrosive fluids from flowing axially between protector 100 and pin end 310 and maintain protector 100 on pin end 310 during impacts. In particular, the axial length L₁₃₀ of external thread 130 is preferably greater than 1.0 in., and more preferably greater than 1.0 in. and less than 1.5 in.

It should be appreciated that internal thread 130 is positioned to sealingly engage the lower portion of external thread 311 distal terminal end 312, thereby restricting and/or preventing corrosive fluids (e.g., water) outside pipe 300 from reaching any portion of the L4 length L₃₁₁ of external threads 311. Sealing engagement of terminal end 312 and base 110 along annular seat 111 restricts and/or prevents corrosive fluids within pipe 300 from reaching any portion of external threads 311.

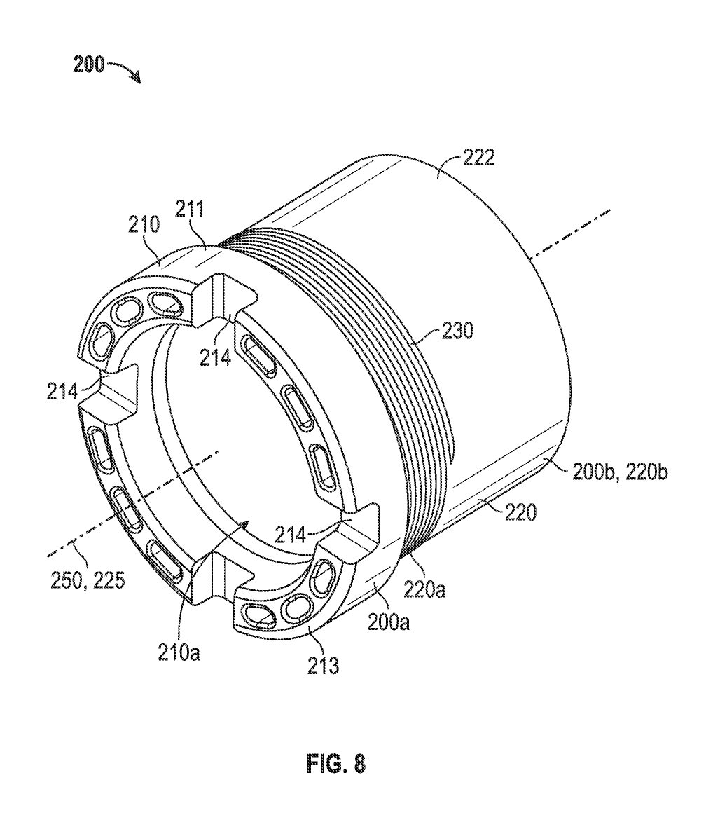

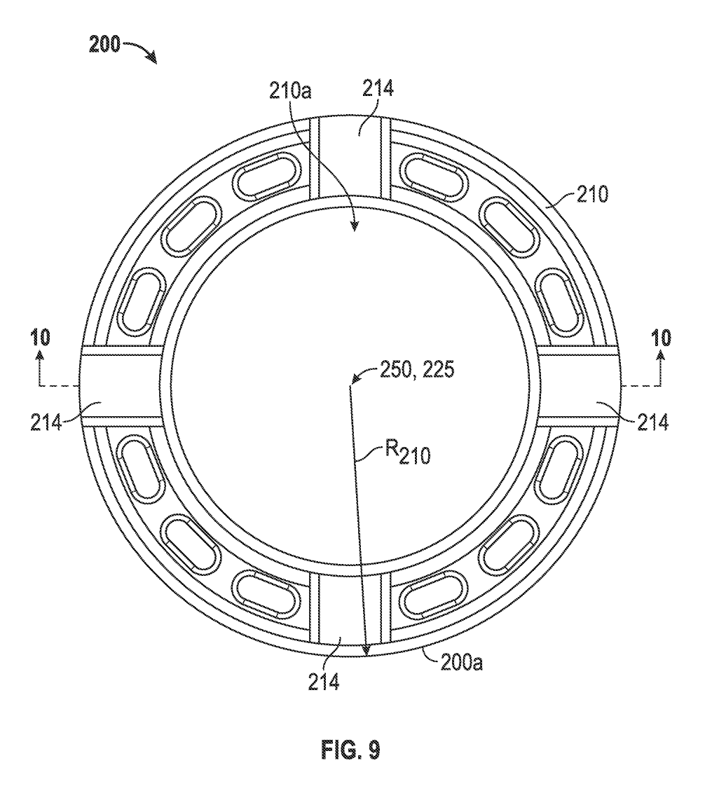

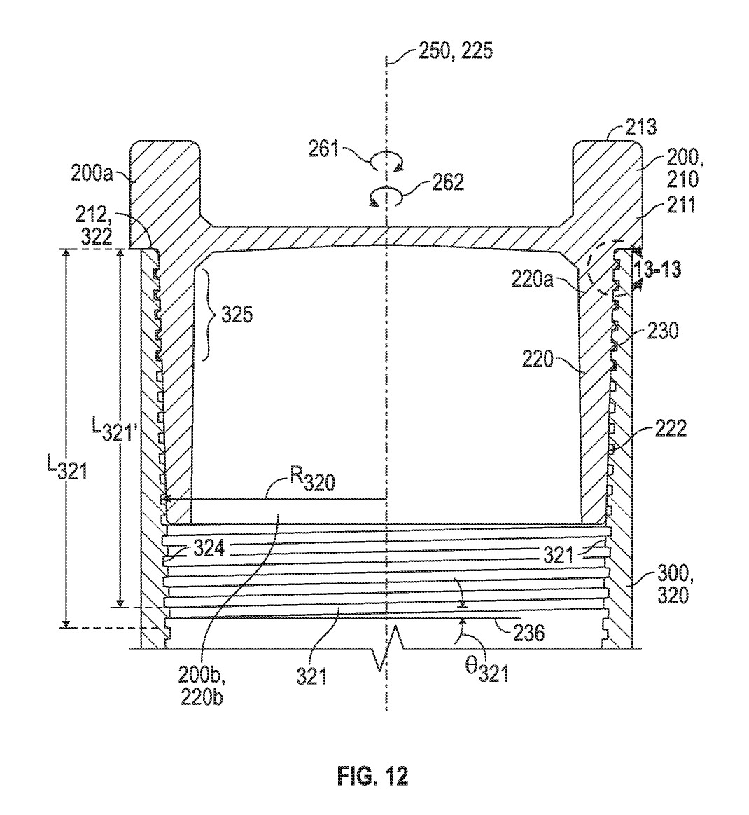

Referring now to FIGS. 8-10 and 12, an embodiment of a box end thread protector 200 in accordance with the principles described herein is shown. In FIG. 12, thread protector 200 is shown coupled to the box end 320 of pipe 300. Box end 320 is opposite pin end 310 previously described. Once mounted to box end 320, thread protector 200 protects internal thread 321 in box end 300 from damage (e.g., impacts with other objects, corrosion, etc.).

Thread protector 200 has a central axis 250, an upper closed end 200a, and a lower open end 200b opposite end 200a. Thread protector 200 has a height H₂₀₀ measured axially between ends 200a, b. In addition, thread protector 200 comprises a base 210 at upper end 200a and an annular body or connecting member 220 extending axially from base 210 to second end 200b. As best shown in FIG. 12, during use, connecting member 220 extends axially into box end 320 of pipe 300 and base 210 axially abuts and sealingly engages terminal end 322 of box end 320. Consequently, connecting member 220 may also be described as a male pin.

Referring still to FIGS. 8-10 and 12, in this embodiment, base 210 is generally circular with an outer radius R₂₁₀. In addition, base 210 has a planar outer surface 210a facing upward away from pin 220 and disposed in a plane oriented perpendicular to axis 250. Further, base 210 extends radially outward beyond pin 220, thereby defining an annular flange 211 extending circumferentially about protector 200. Flange 211 defines a planar annular seat 212 that faces downward toward pin 220 and is disposed in a plane oriented perpendicular to axis 250. As best shown in FIG. 12, seat 212 sealingly engages terminal end 322 of box end 320. An annular bumper 213 extends axially from outer surface 210a of base 210 proximal the radially outer periphery of base 210. Bumper 213 includes a plurality of circumferentially-spaced recesses 214. In this embodiment, four uniformly circumferentially-spaced recesses 214 are provided. Recesses 214 provide a structure and mechanism for positively engaging thread protector 200 and applying rotational torque to thread protector 200 to rotate thread protector 200 about axis 250 during installation and removal from box end 320. Although four recesses 214 uniformly angularly spaced 90° apart about axis 250 are provided in the embodiment shown in FIGS. 8-10 and 12, in general, any suitable number of recesses (e.g., recesses 214) may be provided, and further, the recesses may be uniformly or non-uniformly angularly spaced.

Referring still to FIGS. 8-10 and 12, pin 220 has a central axis 225 coaxially aligned with axis 250, an upper base end 220a connected to base 210, and a lower free end 220b distal base 210. A central passage or bore 221 extends axially through pin 220 between ends 220a, b and is adapted to be at least partially disposed inside box end 320 of pipe 300 (FIG. 12). At end 220a, base 210 extends across, closes off, and occludes bore 221. In this embodiment, bore 221 is open at end 220b, however, since bore 221 is not configured to receive any portion of pipe 300, in other embodiments, the free lower end (e.g., end 220a) may be closed.

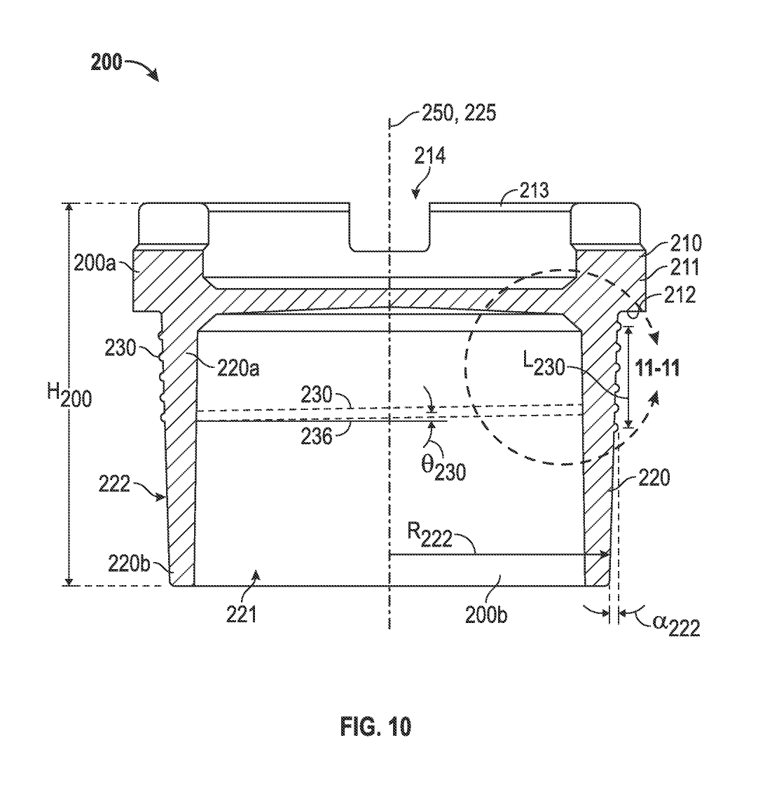

Pin 220 has a radially outer surface 222 defining an outer radius R₂₂₂. As best shown in FIG. 10, in this embodiment, outer surface 222 tapers radially inward moving from end 220a to end 220b. In particular, outer surface 222 is oriented at an acute angle α₂₂₂ relative to pin axis 225. Thus, surface 222 may be described as being frustoconical. As a result, radius R₂₂₂ decreases moving axially from base end 220a to free end 220b.

Referring now to FIGS. 8, 10, and 11, a helical external thread 230 extends along outer surface 222 of pin 220 and is positioned between ends 220a, b. Thread 230 extends about a helical axis that is coincident with axes 225, 250, and has a thread pitch P₂₃₀ equal to the axial width (center-to-center) of one complete turn of thread 230. in this embodiment, thread 230 is positioned proximal base end 220a and axially spaced from free end 220b, Further, as best shown in FIG. 10, thread 230 extends a length L₂₃₀ measured axially (center-to-center) between the upper and lower ends of thread 130. In this embodiment, axial length L₂₃₀ is less than the L4 length L₃₂₁ of internal thread 321 on box end 320, and more specifically, less than the L2 length L321′ of internal thread 321. internal thread 321, L4 length L₃₂₁, and L2 length L_{321′} are described in more detail below.

As best shown in FIG. 10, thread 230 is oriented at a thread angle θ₂₃₀ relative to a reference plane 236 oriented perpendicular to axis 250. Without being limited by this or any particular theory, thread angle θ₂₃₀ is a function of outer radius R₂₂₂ and thread pitch P₂₃₀. In general, for box end thread protectors (e.g., thread protector 200), the thread angle (e.g., thread angle θ₂₃₀) is inversely related to the thread protector outer radius (e.g., inner radius R₂₂₂), and directly related to the thread pitch (e.g., thread pitch P₂₃₀). In other words, for a particular thread pitch, as thread protector outer radius increases, thread angle decreases; and for a particular thread protector outer radius, as thread pitch increases, thread angle increases.

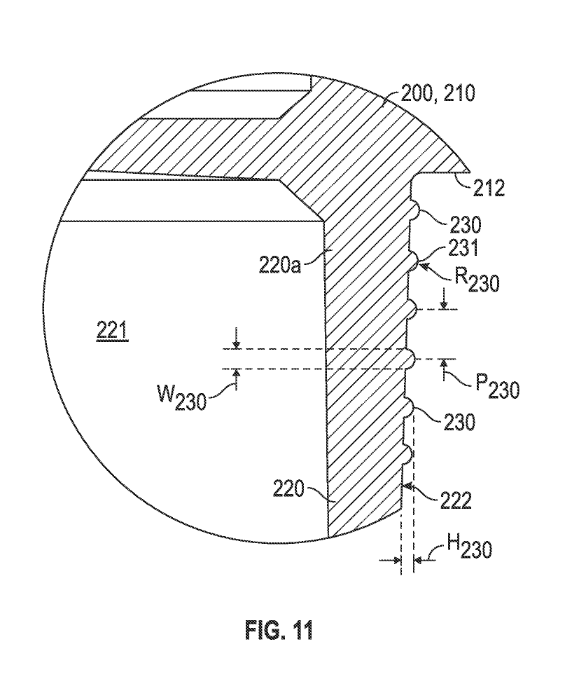

Referring now to FIG. 11, an enlarged partial cross-sectional view of external thread 230 is shown. As previously described, the cross-sectional shape of a thread (e.g., thread 230) taken perpendicular to the central axis of the thread may be referred to its geometry or thread profile. In this embodiment, thread 230 has a round, semi-circular or semi-cylindrical profile defined by a convex surface 231 extending radially outward from surface 222. Surface 231 of thread 230 has a radius of curvature R₂₃₀ that is preferably greater than 0.03 in., and more preferably between 0.045 and 0.06 in. In addition, thread 230 has an axial width W₂₃₀ measured at the base of thread 230 equal to twice the radius R₂₃₀ and one-half thread pitch P₂₃₀, and a thread height H₂₃₀ measured radially outward from surface 223 to the radially outermost point of thread 230. For most applications, thread height H₂₃₀ is preferably between 0.015 in. and 0.05 in., and more preferably between 0.020 in. and 0.035 in.

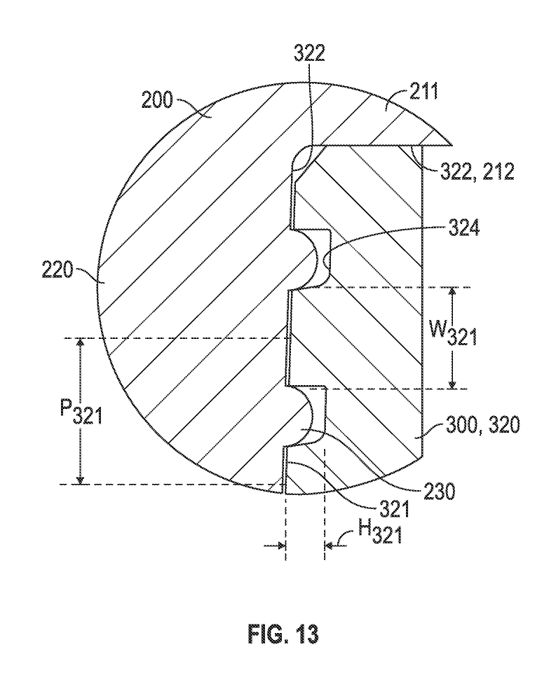

Referring now to FIGS. 12 and 13, box end thread protector 200 is shown mounted to the box end 320 of conventional pipe 300. Box end 320 has a frustoconical radially inner surface 324 defining an inner radius R₃₂₀. As is conventional for drilling and production pipes, inner surface 324 tapers inward moving axially from terminal end 322. Thus, inner radius R₃₂₀ decreases moving axially away from terminal end 322. For most pipes, the inner surface of the box end (e.g., inner surface 324 of box end 320) is usually tapered at an angle between 0° and 3° relative to the central axis of the pipe, most often between 1° and 2°. Angle θ₂₂₂ of outer surface 222 previously described is preferably selected such that outer surface 222 is parallel to the tapered inner surface 324 when protector 100 is mounted to box end 320. In other words, angle α₂₂₂ of surface 222 is preferably the same as the angle of the radially inner surface of the box end to which it is mounted. In applications where the outer surface of the pin end is not tapered (e.g., surface 324 of box end 320 is not tapered), the outer surface of the pin (e.g., outer surface 222 of pin 220) may be cylindrical (i.e., have a constant radius).

Internal helical thread 321 of box end 220 extends within box end 220 and has a runout or L4 length L₃₂₁ measured axially from terminal end 322 to the vanishing point of thread 321. In addition, internal thread 321 has an L2 length L_{321′} measured axially from terminal end 322 to the last full, perfect thread 321. As best shown in FIG. 13, internal thread 321 has a thread pitch P₃₂₁ equal to the axial (center-to center) width of one complete turn of thread 321, a thread height H₃₂₁ measured radially inward from surface 324 to the radially innermost point of thread 321, a thread width W₃₂₁ equal to one-half thread pitch P₃₂₁, a thread angle θ₃₂₁ relative to reference plane 236, and a trapezoidal thread geometry or profile. The box end of conventional pipes (e.g., pipe 300) typically has 5 to 10 external threads per inch, and thus, usually has a thread pitch between 0.1 in. and 0.2 in.

As previously described, external thread 230 has a round, semi-circular or semi-cylindrical profile, whereas internal thread 321 has a trapezoidal profile. Although threads 230, 321 have different thread profiles (i.e., round vs. trapezoidal), external thread 230 is configured to threadingly mate with internal thread 321 (i.e., each turn of thread 230 is axially disposed between a pair of axially adjacent turns of thread 321). In particular, thread pitch P₂₃₀ of external thread 230 is the same as the thread pitch P₃₂₁ of internal thread 321, and thread angle θ₂₃₀ of thread 230 is the same as the thread angle θ₃₃₁ of the internal thread 321. In addition, protector 200 is sized such that external thread 230 radially overlaps with internal thread 321 when thread protector 200 is threaded onto to box end 320. Accordingly, outer radius R₂₂₂ plus external thread height H₂₃₀ is greater than inner radius R₃₂₀ minus internal thread height H₃₂₁ in a region of threaded engagement 325 between threads 230, 321. However, internal thread 321 preferably does not engage outer thread protector surface 222, and external thread 230 preferably does not engage inner box end surface 324 when thread protector 200 is mounted to box end 320. Thread height H₂₃₀ of external thread 230 may be different than thread height H₃₂₀ of internal thread 321, and thread width W₂₃₀ may be different than thread width W₃₂₀ of internal thread 321, while still allowing thread 230 to mate and engage with internal thread 321.

A conventional box end thread protector is sized and configured to fit a box end having a specific combination of diameter, thread pitch, thread angle, thread profile, thread width, and thread height. Embodiments of box end thread protector 200 described herein are sized and configured to fit a box end having a specific combination of diameter, thread pitch, and thread angle, but unlike conventional pin end thread protectors, may be used with different combinations of thread profile, thread width, and thread height. In particular, embodiments of box end protector 200 described herein include an external thread 230 with a round, semi-circular or semi-cylindrical thread profile for sufficiently engaging any box end internal thread 321 having a thread width W₃₂₀ between 90 and 110% of thread width W₂₃₀ (i.e., thread width W₂₃₀ ranges from 90 to 110% of thread width W₃₂₀), and a thread height W₃₂₀ between 100 and 125% of thread height W₂₃₀ (i.e., thread height H₂₃₀ ranges from 80 to 100% of thread height H₃₂₀) This combination of features enables box end thread protector 200 to be mounted onto a variety of different pin ends having a given diameter, thread pitch, and thread angle, but different thread profiles, thread heights, and thread widths, while simultaneously ensuring the threaded engagement therebetween is sufficient to pass the standards and tests relating to box end thread protectors such as the API Specification 5CT/ISO 11960 Requirements for Thread Protector Design Validation including stability tests, torque and vibration tests, axial impact tests, angular impact tests, corrosion test, etc. Accordingly, embodiments of box end thread protector 200 offer the potential for a more versatile thread protector capable of being used with similarly sized pipes having different thread profiles, thread heights, and thread widths. As a result, embodiments of box end thread protector 200 also offer the potential to reduce thread protector inventory and storage requirements by reducing the number of different thread protectors that must be manufactured and stored to account for all the possible combinations of thread profile, thread width, and thread height for given diameter pin ends having a certain thread pitch and thread angle.

Referring now to FIG. 12, to mount thread protector 200 to box end 320, end 200b is axially inserted into box end 320 and axially advanced until external thread 230 at end 220b abuts internal thread 321. Next, rotational torque is applied to thread protector 200 via recesses 214 to rotate thread protector 200 about axis 250 relative to pipe 300 in the direction of arrow 261. Simultaneous with the rotation of thread protector 200, box end 320 is axially urged into box end 320, thereby engaging threads 230, 320 and threading box end thread protector 200 into box end 320. Protector 200 is preferably threaded into box end 320 until terminal end 322 axially abuts and sealing engages flange 211 along seat 212.

To unthread and remove box end thread protector 200 from box end 320, rotational torque is applied to thread protector 200 via recesses 214 to rotate thread protector 200 about axis 250 relative to pipe 300 in the direction of arrow 262 (opposite the direction 261). Simultaneous with the rotation in direction 262, thread protector 200 is axially pulled from box end 320 until threads 230, 321 are completely disengaged.

As previously described, the external threads of a conventional box end thread protector typically engage the L4 length of the internal threads of the corresponding box end, or at least the L2 length of the internal threads. However, in embodiments described herein, external thread 230 of thread protector 200 extends an axial length L₂₃₀ that is less than the L4 length L₃₂₁ of internal threads 321 on box end 320, and further, less than the L2 length L_{321′} of internal threads 321. Thus, external thread 230 does not engage the L4 length L₃₂₁ or L2 length L_{321′} of internal threads 321. This enables thread protector 200 to be installed/threaded into and unthreaded/removed from box end 320 with less time and effort as compared to a similarly sized conventional thread protector. In particular, with a shorter axial length external thread 230, protector 200 may be threaded into and unthreaded from box end 320 with fewer rotations. However, axial length L₂₃₀ is preferably long enough to enable sufficient engagement of threads 230, 321 to restrict and/or prevent corrosive fluids from flowing axially between protector 200 and box end 320 and maintain protector 200 on box end 320 during impacts. In particular, the axial length L₂₃₀ of internal thread 321 is preferably greater than 1.0 in., and more preferably greater than 1.0 in. and less than 1.5 in. It should be appreciated that external thread 230 is positioned to sealingly engage the upper portion of internal threads 321 proximal terminal end 322, thereby restricting and/or preventing corrosive fluids (e.g., water) from reaching any portion of the L4 length of internal threads 321.

The embodiment of pin end thread protector 100 shown in FIGS. 2-6 is a unitary, single-piece structure, in particular, base 110, including bumper 112, and connecting member 120 are cast, molded, or otherwise formed together as a single piece. Thus, base 110 and connecting member 120 are monolithic. In other embodiments, two or more sections of the pin end thread protector (e.g., base 110, connecting member 120, bumper 112, etc.) may be formed as separate pieces that are then attached to each other. Similar to pin end thread protector 100, the embodiment of box end thread protector 200 shown in FIGS. 8-12 is a unitary, single-piece structure. In particular, base 210, including bumper 213, and pin 220 are cast, molded, or otherwise formed as a single piece. In other embodiments, two or more sections of the box end thread protector (e.g., base 210, pin 220, bumper 213, etc.) may be formed as separate pieces that are then attached to each other.

Pin end thread protector 100 and box end thread protector 200 are each preferably constructed of a durable, corrosion resistant material that plastically deforms under impact so that the impact energy is transformed into internal friction and thermal energy; the thread protectors 100, 200 thus using up or substantially reducing the transmitted energy and preventing the energy from reaching or damaging the threads of the attached pipe 300. Each thread protector 100, 200 is thus preferably constructed of a material that will absorb substantial energy when subjected to external forces, such as the impact energy. The material absorbs the impact energy by deflecting, deforming or flexing and/or yielding or failing, each of these requiring energy. Examples of suitable materials for embodiments of thread protectors described herein (e.g., thread protectors 100, 200) include, without limitation, high density polyethylene materials (e.g., Phillips 66 Marlex.™ HHM 5502 BN or HXM 50100).

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the invention. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2) (3) before steps in a method claim are not intended to and do not specify a particular order to the steps, but rather are used to simplify subsequent reference to such steps.

What is claimed is:

1. A protector for protecting a helical thread of a pipe having a central axis, a thread pitch Pₚ, a radial thread height Hₚ, an axial thread width Wₚ, an L4 length, an L2 length, and a thread profile, the protector comprising:
a body having an central axis, an upper end comprising a base, a lower end opposite the upper end, and an annular connecting member extending axially from the base to the lower end, the connecting member comprising a radially inner surface and a radially outer surface;
wherein the connecting member comprises a helical thread extending radially inward from the radially inner surface or radially outward from the radially outer surface; and
wherein the helical thread comprises a convex profile that is different than the thread profile of the helical thread of the pipe.

2. The protector of claim 1, wherein the convex profile is defined by a semi-cylindrical surface extending radially inward from the radially inner surface or radially outward from the radially outer surface.

3. The protector of claim 1, wherein the convex profile comprises a radius of curvature greater than 0.03 in.

4. The protector of claim 3, wherein the radius of curvature is between 0.045 in. and 0.06 in.

5. The protector of claim 2, wherein the helical thread of the connecting member has an axial length L₁ that is less than the L2 length.

6. The protector of claim 5, wherein the axial length L₁ is greater than 1.0 in. and less than 1.5 in.

7. The protector of claim 6, Wherein the helical thread is positioned proximal the base and axially spaced from the lower end or proximal the lower end and axially spaced from the base.

8. The protector of claim 2, wherein the helical thread of the connecting member has a thread pitch P₁ that is the same as the thread pitch Pₚ;
wherein the helical thread of the connecting member has an axial thread width W₁ that is 90 to 110% of the thread width Wₚ; and
wherein the helical thread of the connecting member has a radial thread height H₁ that is 80 to 100% of the thread height Hₚ.

9. The protector of claim 1, wherein the radially inner surface or the radially outer surface of the connecting member is a frustoconical surface oriented at an acute angle relative to the central axis of the protector.

10. The protector of claim 1, wherein the connecting member and the helical thread are configured to mate and engage the helical thread of the pipe having the thread pitch Pₚ, the radial thread height Hₚ, and the axial thread width Wₚ; and
wherein the connecting member and the helical thread are configured to mate and engage a second helical thread of a second pipe having the thread pitch Pₚ, a second radial thread height Hₚ, that is different than the radial thread height Hₚ, and an axial thread width W_{p′} that is different than the axial thread width Wₚ.

11. A method for protecting a pipe thread, the method comprising:
providing a thread protector having a central axis and comprising:
a base;
an annular connecting member extending axially from the base, time connecting member having a radially inner surface and a radially outer surface;
wherein the radially outer surface or the radially inner surface of the connecting member includes a helical thread;
wherein the helical thread has a convex profile;
coaxially aligning the thread protector with a pipe, wherein the pipe has a radially outer surface, a radially inner surface, and a helical thread extending from a terminal end of the pipe along the radially inner surface or the radially outer surface of the pipe, the helical thread of the pipe having a thread profile that is different from the convex profile of the helical thread of the connecting member;
rotating the thread protector in a threading direction about the central axis and advancing the thread protector and the terminal end of the pipe axially together; and
threadingly engaging the helical thread of the pipe with the helical thread of the thread protector.

12. The method of claim 11, further comprising:
forming an annular seal between the terminal end of the pipe and the base.

13. The method of claim 12, further comprising:
preventing fluid from passing axially between the helical thread of the pipe and the helical thread of the thread protector after threadingly engaging the helical thread of the pipe with the helical thread of the thread protector; and
preventing fluid from passing radially between the terminal end of the pipe and the base after forming an annular seal between the terminal end of the pipe and the base.

14. The method of claim 11, wherein the convex profile is defined by a semi-cylindrical surface extending radially outward from the radially outer surface or radially inward from the radially inner surface of the connecting member; and
wherein the convex profile has a radius of curvature greater than 0.03 in.

15. The method of claim 12, wherein the helical thread of the thread protector engages less than an L2 length of the helical thread of the pipe.

16. The method of claim 15, wherein the helical thread of the thread protector engages the helical thread of the pipe over an engagement region that has an axial length of at least 1.0 in. and less than 1.5 in.

17. The method of claim 11, wherein the helical thread of the thread protector has a thread pitch that is the same as a thread pitch of the helical thread of the pipe;
wherein the helical thread of the thread connector has an axial thread width that is 90 to 110% of a thread width of the helical thread of the pipe; and
wherein the helical thread of the thread protector has a radial thread height that is 80 to 100% of a thread height of the helical thread of the pipe.

18. An assembly, comprising:
a pipe having a central axis, a radially inner surface, a radially outer surface, and a helical thread extending about the radially outer surface or the radially inner surface of the pipe, wherein the helical thread of the pipe has a thread with Pₚ, a radial thread height Hₚ, an axial thread width Wₚ, an L4 length, an L2 length that is less than the L4 length, and a thread profile; and
a thread protector threadingly coupled to the pipe, wherein the thread protector has a central axis and comprises a base and an annular connecting member having a first end connected to the base and a second end distal the base;
wherein the connecting member comprises a radially inner surface, a radially outer surface, and a helical thread extending about the radially inner surface or the radially outer surface of the connecting member;
wherein the helical thread of the connecting member is positioned between the first end and the second end of the connecting member;
wherein the helical thread of the connecting member has an axial length that is less than the L2 length of the helical thread of the pipe.

19. The assembly of claim 18, wherein the helical thread of the thread protector has a convex profile that is different than the thread profile of the thread of the pipe.

20. The assembly of claim 19, wherein the convex profile is defined by a semi-cylindrical surface extending radially inward from the radially inner surface or radially outward from the radially outer surface of the connecting member.

21. The assembly of claim 20, wherein the convex profile has a radius of curvature greater than 0.03 in.

22. The assembly of claim 19, wherein the axial length of the helical thread of the connecting member is greater than 1.0 in. and less than 1.5 in.

23. The assembly of claim 18, wherein the helical thread is positioned proximal the first end and axially spaced from the second end or positioned proximal the second end and axially spaced from the first end.

24. The assembly of claim 18, wherein the helical thread of the connecting member has a thread pitch that is the same as a thread pitch of the helical thread of the pipe;
wherein the helical thread of the connecting member has an axial thread width that is 90 to 110% of a thread width of the helical thread of the pipe; and
wherein the helical thread of the connecting member has a radial thread height that is 80 to 100% of a thread height of the helical thread of the pipe.
